(19) United States
(12) Patent Application Publication
(10) Pub. No.: US 2012/0248333 A1
(43) Pub. Date: Oct. 4, 2012

(54) Device For Fluorescence Diagnosis

(76) Inventors: Johannes Fallert, Tuttlingen (DE); Peter Schwarz, Tuttlingen-Nendingen (DE); Werner Goebel, Singen (Hohentwiel) (DE); Andre Ehrhardt, Wurmlingen (DE); Klaus-Martin Irion, Emmingen-Liptingen (DE)

(21) Appl. No.: 13/430,174

(22) Filed: Mar. 26, 2012

(30) Foreign Application Priority Data
Mar. 30, 2011 (DE) 10 2011 016 138.4

(51) Int. Cl. G01N 21/64

(52) U.S. Cl. 250/458.1; 250/208.1

(57) ABSTRACT

A diagnosis device having an illumination system configured to produce white light along an illumination path, an observation system for observing the target region in a white-light and fluorescence mode, the observation system having an observation path having at least one first image sensor for receiving a white-light image and at least one second image sensor for receiving a fluorescence image, an observation spectral filter in the observation path are configured such that light in the spectral range of the fluorescence can be fed to the second image sensor while light in the spectral ranges outside of the fluorescence is blocked. An illumination spectral filter is arranged in the illumination path and having a characteristic of the observation spectral filter such that the target region is illuminated with the whole spectral range of the white light with the exception of the spectral range of the fluorescence to be observed.

### CROSS REFERENCE TO RELATED APPLICATION

This application claims priority from German patent application No. 10 2011 016 138.4 filed on Mar. 30, 2011.

### BACKGROUND OF THE INVENTION

The invention relates to a device for fluorescence diagnosis, comprising an illumination system for illuminating a target region, and an observation system for observing the target region in a white-light mode and in a fluorescence mode.

A device according to the invention for fluorescence diagnosis, of the type specified at the outset, is preferably used for medical diagnostic purposes, but it can also be used for technical diagnostic purposes in industrial or scientific applications.

Within the scope of medical fluorescence diagnosis, a device of the type specified at the outset is used to assess the state of biological tissue, for example for differentiating between tissue in general, more particularly for identifying tumours, but also for identifying perfusion and vitality. Using a device for fluorescence diagnosis, of the type specified at the outset, it is possible, in particular, to carry out the fluorescence diagnosis in vivo.

In the case of fluorescence diagnosis, light is used to excite a fluorescent substance present in the target region to fluoresce. In the process, a fluorescent substance can be a fluorescent dye, a pigment, etc., which was previously introduced into the target region, for example by administering the fluorescent substance or a precursor thereof to a patient. However, a fluorescent substance can also be a substance already present in the target region, for example a tissue-specific substance that is excited to autofluorescence by the fluorescence diagnosis. The present invention can comprise both cases. For the purposes of the following explanations, the assumption is made that the fluorescent substance is a fluorescent dye, which is introduced exogenously (from the outside) into the target region, i.e. into the tissue area to be examined.

To this end, the fluorescent dye or an initial form of this fluorescent dye is administered to the patient to be examined. In the fluorescence diagnosis for examining tissue, 5-aminolevulinic acid is for example administered to the patient as initial substance, from which the fluorescent dye protoporphyrin IX (PₚIX) is formed intracellularly by heme biosynthesis. The fluorescence diagnosis utilizes the fact that the fluorescent dye, protoporphyrin IX in the present case, is enriched more strongly in malignant tissue, e.g. tumour tissue, than in healthy tissue.

The fluorescent dye can be excited to fluoresce by illumination with light in a spectral range in which the fluorescent dye exhibits absorption. By way of example, the fluorescent dye protoporphyrin IX absorbs most strongly in a spectral range around 400 nm (Soret band), i.e. in the violet-blue visible spectral range. The fluorescent light always has a longer wavelength than the excitation light, and in the case of the fluorescent dye protoporphyrin IX, the fluorescence emission lies in the visual spectral range with a maximum at 635 nm and a further, weaker peak at 705 nm, i.e. in the red visible spectral range. As a result of the large Stokes shift of PₚIX, the intensity of the emitted fluorescent light is significantly smaller than the intensity of the reflected excitation light.

A device for fluorescence diagnosis is known from US 2003/0078477 A1, which can be operated in two modes of operation: a white-light mode and a fluorescence mode to be precise. In the fluorescence mode, the light source, e.g. a mercury lamp or a xenon lamp, is operated such that it emits light with a wavelength in the spectral range from 380 nm to 580 nm. In the fluorescence mode, light of this wavelength is directed to the target region, where it excites the fluorescent dye protoporphyrin IX to fluoresce. Moreover, the illumination light radiated into the target region is reflected in the target region. Both the reflected light and the fluorescence light are then routed via the observation path to two image sensors, of which one is configured to receive a white-light image and the other is configured to receive a fluorescence image. In order to prevent the broad-band, reflected illumination light from reaching the image sensor for receiving the fluorescence image, the known device provides a dichroic mirror, which acts as a wavelength-selective beam splitter, with the dichroic mirror passing the broad-band, back-reflected light and directing the narrow-band fluorescence light to the image sensor for receiving the fluorescence image. Hence it is possible to receive, simultaneously, both a fluorescence image and a white-light image in the fluorescence mode of this known device. However, since the illumination light in the fluorescence mode is restricted in a wavelength range between 380 nm and 580 nm, the received white-light image is not a true-colour image because red components of the visible light are missing in the white-light image. The fluorescence image and the white-light image, which is unsatisfactory in terms of colour fidelity, are displayed superposed on one another on a monitor by means of an image processing system.

For the purposes of a white-light image with colour fidelity, the known device must be switched into the white-light mode, with the dichroic mirror then being pivoted out of the observation path. As a result of this, the image sensor for receiving the white-light image also receives components in the red spectral range.

A disadvantage of this known device is that, in the fluorescence mode, the device does not afford the possibility of generating a white-light image with colour fidelity in addition to the fluorescence image and, in order to generate a white-light image, the device must be switched into the white-light mode. This not only makes the handling of the known device complicated, it also increases the design complexity as a result of switching the light source and the pivoting in and out of the dichroic mirror.

A further device for fluorescence diagnosis is known from DE 10 2009 018 141 A1. This known device can likewise be operated in a white-light mode and in a fluorescence mode, with, however, there only being one image sensor in this device, which image sensor is used both for receiving a white-light image and also for receiving a fluorescence image.

In the fluorescence mode, an illumination spectral filter is arranged in the illumination path and it is transmissive in a narrow-band excitation spectral range for exciting the fluorescence and substantially opaque in the spectral range on the long wavelength side outside of the excitation spectral range. This illumination spectral filter is only arranged in the illumination path if the device is operated in the fluorescence mode, while it is removed from the illumination path in the white-light mode. An observation spectral filter is arranged in the observation path both in the white-light mode and in the fluorescence mode, and it is transmissive in the spectral ranges on the short wavelength side and on the long wavelength side outside of the excitation spectral range. This provides a largely natural colour impression when observing the target region in the white-light mode. In the fluorescence mode, in which the illumination spectral filter is arranged in the illumination path, the known device can transmit the fluorescence image with the same observation spectral filter that is also used in the white-light mode.

However, it is likewise a disadvantage of this known device that it is necessary to switch between the fluorescence mode and the white-light mode, with the illumination spectral filter having to be introduced into or removed from the illumination path during the switch.

A further disadvantage of the known device consists of the fact that the observation system only has one image sensor both for receiving the white-light image and for receiving the fluorescence image. In the fluorescence mode, this image sensor must be operated with an increased exposure time and/or gain in order to increase the usually relatively weak fluorescence signal to an acceptable value. Hence, the illustrated image is usually very much slowed down and/or noisy in the fluorescence mode.

There have also been attempts to avoid having to switch continuously between the white-light mode and the fluorescence mode by adding relatively weak white light to the fluorescence image. However, the white-light information additionally introduced into the fluorescence image in this manner is nowhere near a usual white-light image in respect of the image quality as a result of the weak illumination.

### SUMMARY OF THE INVENTION

It is an object to provide a device for fluorescence diagnosis which can be simultaneously operated in the fluorescence mode and white-light mode such that there is no need to switch between the two modes of operation.

It is a further object to provide a device for fluorescence diagnosis with which a high-quality white-light image can be obtained.

According to an aspect of the invention, a device for fluorescence diagnosis is provided, comprising an illumination system configured to illuminate a target region, having a light source configured to produce white light, an illumination path, an illumination spectral filter arranged in the illumination path; an observation system configured to observe the target region in a white-light mode and in a fluorescence mode, having an observation path, at least one first image sensor configured to receive a white-light image, at least one second image sensor configured to receive a fluorescence image, an observation spectral filter arranged in the observation path and associated with the second image sensor, a beam splitter arranged in the observation path and dividing the observation path into a first sub-path and into a second sub-path, with light along the first sub-path being directed to the first image sensor and light along the second sub-path being directed to the second image sensor; the observation spectral filter having a first filter characteristic configured such that light in a fluorescence spectral range of a fluorescence to be observed can be fed to the second image sensor while light in spectral ranges outside of the fluorescence is blocked; the illumination spectral filter being arranged in the illumination path in both the white-light mode and the fluorescence mode, the illumination spectral filter having a second filter characteristic matched to the first filter characteristic of the observation spectral filter such that the target region is illuminated with a whole spectral range of the white light with exception of the fluorescence spectral range of the fluorescence to be observed.

The design and function of the device according to the invention is based on a novel concept over the known devices, this concept no longer requiring that the observation filter in the camera or in the endoscope be switched between the fluorescence mode and the white-light mode. This is achieved by virtue of illuminating the target region with almost the whole spectral range of the white light emitted by the light source, even in the fluorescence mode, with merely a narrow-band spectral range of the visible light missing from the illumination light, to be precise that of the fluorescence to be observed. To this end, according to the invention, an illumination spectral filter is arranged in the illumination path, the filter characteristic of said illumination spectral filter being matched to the filter characteristic of the observation spectral filter associated with the second image sensor, which serves to receive the fluorescence image, such that the target region is illuminated with the whole spectral range of the white light with the exception of the spectral range of the fluorescence to be observed, with the filter characteristic of the illumination spectral filter being selected such that the illumination light is blocked in the range of the fluorescence. According to the invention, this range is selected as narrowly as possible. The observation spectral filter preferably has a transmissive range with a bandwidth of less than or equal to 50 nm. This illumination spectral filter is arranged in the illumination path both in the fluorescence mode and in the white-light mode. Since only a narrow-band spectral range of the white light is filtered out of the illumination light, a white-light image of high quality in terms of colour fidelity and luminosity is obtained at all times. Hence, the device according to the invention allows simultaneous observation of a fluorescence image and a white-light image, the latter having high colour fidelity.

The device according to the invention offers the user very good orientation in the observed target region, for example a tissue area, during the fluorescence diagnosis.

A beam splitter is preferably arranged in the observation path, which beam splitter divides the observation path into a first sub-path and into a second sub-path, with light along the first sub-path being directed to the first image sensor and light along the second sub-path being directed to the second image sensor.

It is advantageous in this case that the observation path, which for example extends through an endoscope, can be passed up to the beam splitter without being split into individual optical channels, while the observation path only needs to be split by the beam splitter in the direct vicinity of the first and the second image sensor. As a result, it is possible to implement the endoscope with a thin shaft diameter. The beam splitter can be arranged in the observation path in the white-light mode as well as in the fluorescence mode.

In a preferred embodiment, the filter characteristic of the illumination spectral filter complements the filter characteristic of the observation spectral filter associated with the second image sensor.

Here, “complements” should be understood to mean that the spectral filter boundaries of the illumination spectral filter and the observation spectral filter, associated with the second image sensor, closely adjoin, preferably that the wavelength spacing between the 50% values of the filter curves of the illumination spectral filter and the observation spectral filter, associated with the second image sensor, is less than 15 nm, more preferably less than 10 nm. This brings about the advantage that the spectral component decoupled from the illumination light, dependent on the fluorescence to be observed, is as small as possible, as a result of which the quality of the white-light image is particularly high.

In a further preferred embodiment, the observation spectral filter associated with the second image sensor is a band-pass filter and the illumination spectral filter is a notch filter.

In this embodiment, the narrow-band transmission range of the observation spectral filter lies in the spectral range of the visible light with its short-wavelength boundary and with its long-wavelength boundary.

This embodiment is particularly preferred in conjunction with the aforementioned embodiment, according to which the filter characteristic of the illumination spectral filter complements the filter characteristic of the observation spectral filter associated with the second image sensor.

This measure is advantageous particularly if the administered fluorescent dye has a narrow-band fluorescence spectrum which lies entirely in the visible spectral range. In this embodiment, the spectral ranges on both sides of the fluorescence spectrum then advantageously are maintained in the white light, as a result of which a high-quality white-light image is obtained. By way of example, in the case of the fluorescent dye fluorescein, the fluorescence of which lies in the green spectral range between 500 and 555 nm, and in the case of the fluorescent dye protoporphyrin IX, the primary fluorescence of which lies in the red spectral range between 620 and 650 nm, this embodiment of the filter characteristics of the illumination spectral filter and of the observation spectral filter, associated with the second image sensor, can be utilized in an advantageous manner. In both cases, a component of the red spectral range that suffices for a high-quality white-light image is maintained in the illumination light and hence in the white-light image.

In a further preferred embodiment, an observation spectral filter is associated with the first image sensor, said observation spectral filter restricting the spectral range of the light incident on the first image sensor to the visible spectral range.

It is advantageous in this case that the sensitivity of the image sensor for receiving the white-light image is matched to the typical eye sensitivity in humans by virtue of the aforementioned observation spectral filter blocking the infrared spectral range in particular. By way of example, a BG 39 filter by Schott AG or a modified filter, which is still transmissive in the deep red, can be used as observation spectral filter associated with the first image sensor.

With respect to the beam splitter, it is preferable for, in the direction of light propagation, the observation spectral filter associated with the second image sensor to be arranged behind the beam splitter and in front of the second image sensor, or for the observation spectral filter associated with the second image sensor to be integrated into the beam splitter.

The alternative mentioned first is advantageous in that it is simple from a production-technical point of view, while the second alternative is advantageous in that it is possible to obtain a higher intensity yield for both the fluorescence image and the white-light image.

In conjunction with the second alternative, a structural implementation is provided, in which the observation spectral filter associated with the second image sensor is reflective in the spectral range of the fluorescence to be observed and transmissive in the remaining spectral range of the light from the white-light source, or vice versa.

In a further preferred embodiment, there is a controller for the first image sensor and/or the second image sensor and it is configured to operate the first image sensor with a short exposure time and/or small gain and/or to operate the second image sensor with a long exposure time and/or high gain and/or in a spatial integration mode.

Operating the first image sensor for receiving the white-light image with short exposure times and low gain is advantageous in that the first image sensor supplies a real-time, low-noise image as a result of receiving relatively high light intensity. By contrast, operating the second image sensor for receiving the fluorescence image with long exposure times, high gains and optionally also with spatial integration is advantageous in that the typically relatively weak fluorescence is amplified to a sufficient extent and hence a perceivable fluorescence image is obtained.

In this context, it is preferable for the controller to be configured to operate the second image sensor in a time-resolved mode.

By way of example, this measure is particularly advantageous in the case of examining leaks in end anastomoses, for example in intestinal surgery, since such leaks are directly visualized for the medical practitioner after a fluorescent dye, e.g. ICG, was administered and since it is also possible to capture the time profile thereof.

In a further preferred embodiment, the second image sensor is configured such that it can also be operated in a so-called time-of-flight mode.

During this measure, the actuation of the second image sensor and the light source is appropriately configured. The aforementioned measure is advantageous in that such a time-of-flight mode enables the determination of the spatially resolved fluorescence decay time. In principle, even in the case of fluorescence emission of a fluorescence marker with the same intensity from different tissue types, this affords the possibility of determining a difference between the tissue types by means of various decay times of the fluorescence. Fluorescence decay time or else fluorescence life should be understood to mean the mean time the fluorescence molecules remain in the excited state after being excited to fluoresce before a fluorescence photon is emitted. Thus, this is not the time profile of the fluorescence intensity, which for example reduces or increases as a result of bleaching effects or the build up of a fluorescent dye in the bloodstream.

In a further preferred embodiment, the observation system has an image processing system which is configured to superpose in the correct position a white-light image captured by the first image sensor, a fluorescence image captured by the second image sensor and the image of the spatially resolved fluorescence decay time.

In this case, it is advantageous that, first, a spatial orientation in the target region is offered to the observer of the fluorescence and white-light image and that, secondly, the fluorescing regions within the target region can also be assigned in a spatially localized manner, as a result of which a spatially precise diagnosis of malignant tissue is made possible.

Here, it is furthermore preferred if the image processing system is configured to superpose the fluorescence image in the form of a false-colour representation on the white-light image.

As a result of this, it is advantageous that a greater contrast is created between the white-light image and the fluorescence image superposed thereon in the former, which allows the diagnosis to become even more precise. Here, different intensities of the fluorescence can be visualized by different colours.

In a further preferred embodiment, the image processing system is configured to superpose the fluorescence image onto the white-light image only if the fluorescence image exceeds a predetermined intensity threshold, or only to superpose those local regions of the fluorescence image onto the white-light image in which the predetermined intensity threshold is exceeded.

This measure advantageously contributes to suppressing the noise in the signal of the fluorescence image by only superposing the latter on the white-light image above an intensity threshold. In conjunction with the false-colour representation, the further advantage emerges here that the spatial intensity profile of the fluorescent region in the target region can be represented by colour gradation or by the association with different colours, which allows the diagnosis to become even more precise.

The observation system preferably has an endoscope, into which the illumination path and/or the observation path is at least partly integrated.

However, the observation system can also have a camera, a microscope or the like.

In the case where the observation system has an endoscope, the endoscope can be a stereo endoscope.

In this case, it is advantageous that a 3D white-light image can be obtained with the stereo endoscope in the white-light mode, and the fluorescence image can be superposed on the 3D white-light image in the fluorescence mode. As a result of the three-dimensional nature of the white-light image, the orientation for the observer is improved even further by using a stereo endoscope, particularly in the white-light mode. Moreover, as a result of the fact that a stereo video endoscope in any case already has two image sensors, the invention can be implemented in a stereo endoscope without much additional complexity.

In an embodiment with a particularly simple design, the stereo endoscope has two optics channels, with one image sensor being arranged in each of the two optics channels; of these image sensors, one serves to receive a fluorescence image, with the observation spectral filter being associated with this image sensor, which observation spectral filter can be pivoted into the beam path in order to capture a fluorescence image and pivoted out of the beam path in order to receive a 3D white-light image together with the other image sensor.

In another embodiment of the stereo endoscope, at least one image sensor for receiving the white-light image is respectively arranged in both optics channels, and at least one further image sensor for receiving a fluorescence image is arranged in at least one of the optics channels. However, respectively one image sensor for receiving a fluorescence image can also be arranged in both optics channels, in each case in addition to the respective image sensor for receiving a white-light image.

Further advantages and features emerge from the following description and the attached drawing.

It is understood that the features, both mentioned above and still to be explained below, can be used not only in the respectively specified combination, but also in any other combination, or on their own, without departing from the scope of the present invention.

### BRIEF DESCRIPTION OF THE DRAWINGS

Exemplary embodiments of the invention are illustrated in the drawings and will, with reference thereto, be described in more detail in the following text. In the drawings:

FIG. 1 shows a device for fluorescence diagnosis in a schematic illustration;

FIG. 2 shows part of an observation system of the device in FIG. 1 in a first exemplary embodiment;

FIG. 3 shows part of an observation system of the device in FIG. 1 as per a further exemplary embodiment;

FIG. 4 shows a diagram of a filter characteristic of an observation spectral filter, associated with a second image sensor for receiving a fluorescence image, and an illumination spectral filter of the device in FIG. 1 as per a first exemplary embodiment;

FIG. 5 shows a further diagram of a filter characteristic of an observation spectral filter, associated with a second image sensor for receiving a fluorescence image, and an illumination spectral filter of the device in FIG. 1 as per a further exemplary embodiment;

FIG. 6 shows an even further diagram of a filter characteristic of an observation spectral filter, associated with a second image sensor for receiving a fluorescence image, and an illumination spectral filter of the device in FIG. 1 as per an even further exemplary embodiment;

FIG. 7 shows an exemplary embodiment of an observation system, implemented in a stereo endoscope, for use in the device in FIG. 1 in place of the observation system shown in FIG. 1; and

FIG. 8 shows a further exemplary embodiment of an observation system, implemented in a stereo endoscope, for use in the device in FIG. 1 in place of the observation system shown in FIG. 1.

### DESCRIPTION OF PREFERRED EXEMPLARY EMBODIMENTS

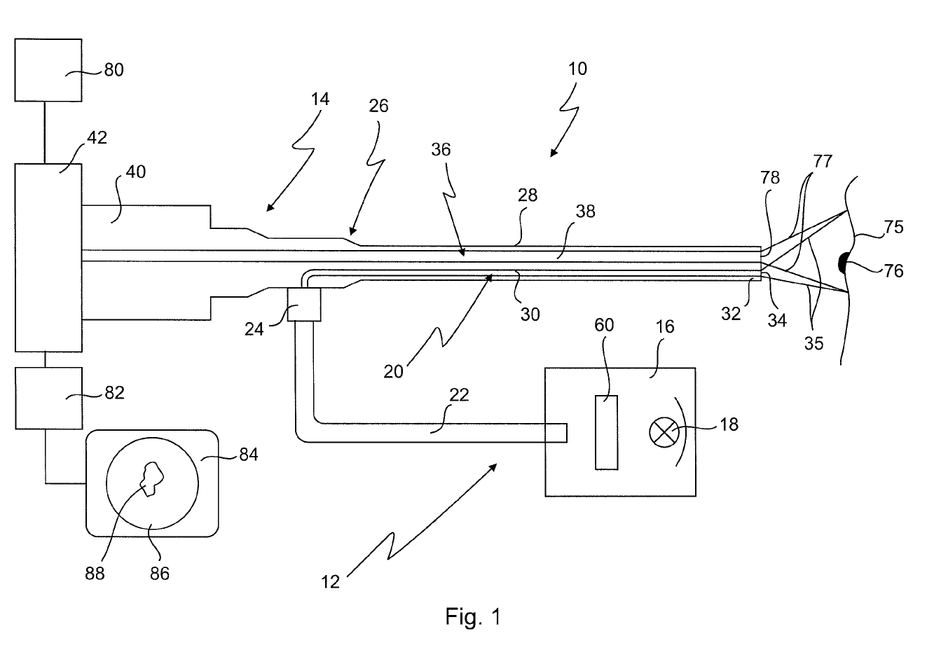

FIG. 1 schematically illustrates a device for fluorescence diagnosis, provided with the general reference sign 10. Without loss of generality, the device 10 is described below on the basis of a use for medical fluorescence diagnosis. However, the device 10 can also be used for technical fluorescence diagnosis for industrial or scientific purposes.

In general, the device 10 has an illumination system 12 and an observation system 14.

The illumination system 12 has a light source 16, which is configured to produce white light. To this end, the light source 16 has a lamp 18 or a lamp system, for example a xenon discharge lamp. However, it is also possible to use other lamps or lamp systems that produce white light, such as, for example, arc discharge lamps, incandescent lamps, LED lamp systems, laser diode systems and the like.

Within the meaning of the present invention, “white light” should be understood to mean polychromatic or spectrally broad-band light, which has a continuous or quasi-continuous spectrum, at least over the visible spectral range.

The illumination system 12 furthermore has an illumination path 20. In the shown exemplary embodiment, the illumination path 20 is, starting from the light source 16, partly implemented by an optical cable 22, which is connected to an optical waveguide connector 24 of an endoscope 26. The endoscope 26 has an elongated shaft 28, through which, starting from the optical waveguide connector 24, the illumination path 20 extends further, in the form of an optical waveguide 30, e.g. in the form of an optical-fibre bundle, to a distal end 32 of the shaft 28. When the light source 16 is switched on, the light emerges from a light-exit face 34 in accordance with a light-exit cone 35.

Hence, in the illustrated exemplary embodiment, the illumination path 20 is partly integrated into the endoscope 26.

The observation system 14 has an observation path 36, which is likewise at least partly integrated into the endoscope 26. The observation path 36 can be implemented in the endoscope 26 in a number of different ways, for example by an ordered optical-fibre bundle 38 or by a relay lens system (not illustrated).

The device 10 can also have a microscope instead of the endoscope 26.

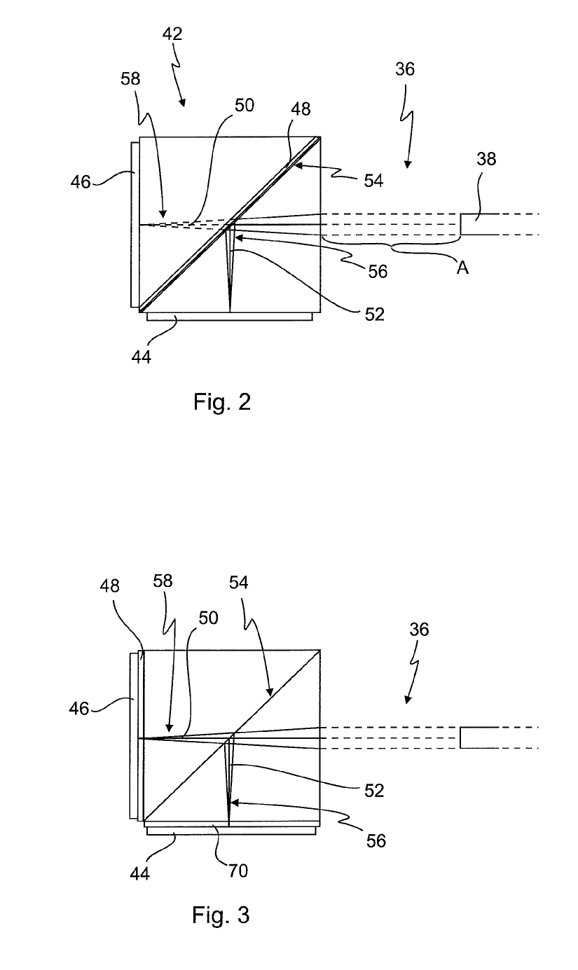

A camera 42, which will be described below with reference to FIG. 2, is connected to a proximal end 40 of the endoscope 26. It is understood that the camera 42 can also be arranged in the region of the distal end 32 of the shaft 28, such that the observation path 36 is correspondingly restricted to the distal region of the endoscope 26.

FIG. 2 shows the camera 42 of the observation system 14 in a schematic, simplified illustration. The camera 42, which is part of the observation path 36, has a first image sensor 44 and a second image sensor 46. It is understood that the camera 42 can have more than the two image sensors 44 and 46.

The first image sensor 44 serves for receiving a white-light image and the second image sensor 46 serves for receiving a fluorescence image. An observation spectral filter 48 is associated with the second image sensor 46 in the observation path 36; the filter characteristic of this observation spectral filter, which will still be described below, is configured such that light in the spectral range of the fluorescence to be observed, i.e. fluorescence light 50, can be fed to the second image sensor 46, while light 52 in the spectral ranges outside of the fluorescence is blocked.

In the exemplary embodiment as per FIG. 2, the observation spectral filter 48, which is associated with the second image sensor 46, is integrated into a beam splitter 54, which divides the observation path 36 into a first sub-path 56 and a second sub-path 58. Hence, the light 52 is directed to the first image sensor 44 along the first sub-path 56 and the light 50 (fluorescence light) is directed to the second image sensor 46 along the second sub-path 58.

In the exemplary embodiment as per FIG. 2, the observation spectral filter 48 is transmissive in the spectral range of the fluorescence to be observed and reflective in the remaining spectral ranges outside of the fluorescence.

An objective, which is usually placed upstream of the image sensors 44 and 46 and is for example arranged in the region A in FIG. 2, has been omitted in FIG. 2 for reasons of clarity.

As an alternative to integrating the observation spectral filter 48 associated with the second image sensor 46, the former can also be arranged between the beam splitter 54 and the second image sensor 46, for example directly in front of the second image sensor 46 such that the light 50 in the region between the beam splitter 54 and the observation spectral filter 48 contains not only the spectral component of the fluorescence, but also the spectral components from outside of the fluorescence. The same applies to the spectral composition of the light 52 in the first sub-path 56. This is shown in FIG. 3.

Once again with reference to FIG. 1, the illumination path 20 has an illumination spectral filter 60, the filter characteristic of which is matched to the filter characteristic of the observation spectral filter 48 associated with the second image sensor 46 such that the illumination light contains the whole spectral range of the white light produced by the light source 16, with the exception of the spectral range of the fluorescence to be observed. The illumination spectral filter 60 is arranged in the light source 16 in FIG. 1; however, it can also be arranged at another point in the illumination beam path 22 before the light emerges from the distal end 32.

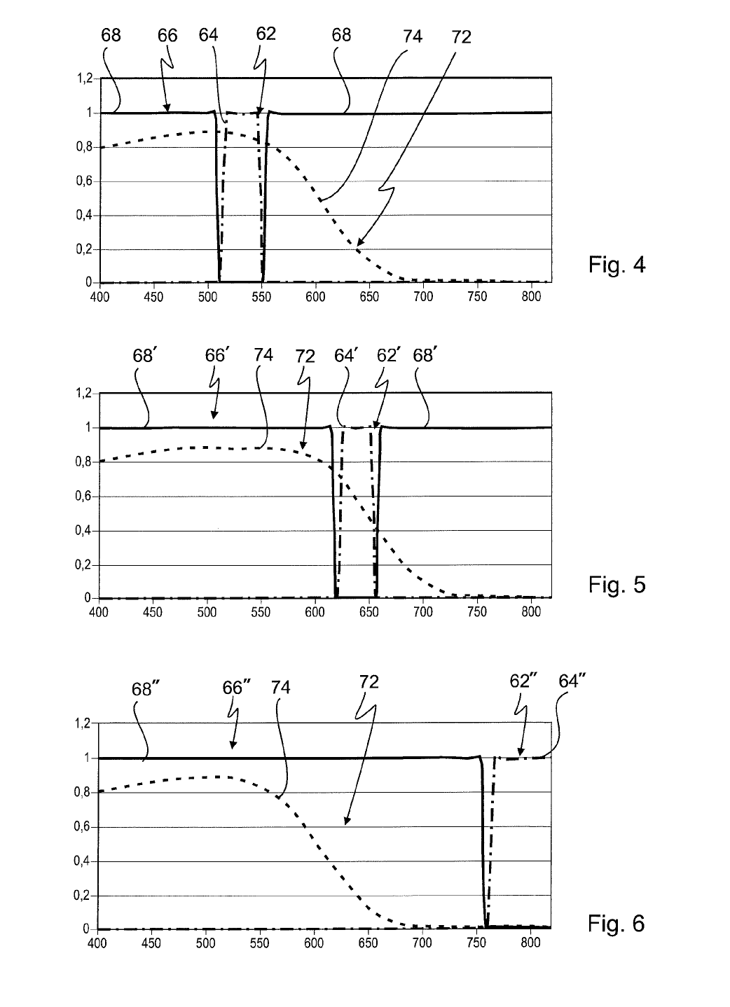

FIGS. 4 to 6 show exemplary embodiments for the filter characteristics of the observation spectral filter 48 and the illumination spectral filter 60.

FIG. 4 shows a filter characteristic 62 of the observation spectral filter 48 associated with the second image sensor 46; according to this, the observation spectral filter 48 is embodied as a band-pass filter. A filter curve 64, which reproduces the profile of the transmission of the observation spectral filter 48, shows that the transmission region of the observation spectral filter 48 is very narrow band and is restricted to the spectral range of approximately 510 to 550 nm in this exemplary case. This embodiment is particularly suitable for the fluorescent dye fluorescein, the fluorescence of which lies in this spectral range.

A filter characteristic 66 of the illumination spectral filter 60 is represented by a filter curve 68; according to this, the illumination spectral filter 60 is a notch filter. As per the filter curve 68, as shown in FIG. 4, the illumination spectral filter 60 is transmissive in all spectral ranges of the visible light, with the exception of the spectral range in which the observation spectral filter 48 is transmissive. By contrast, in the spectral range of the fluorescence to be observed, in which the observation spectral filter 48 is transmissive, the illumination spectral filter 60 is opaque.

FIG. 5 shows a further exemplary embodiment for the filter characteristics 62′, of the observation spectral filter 48, and 66′, of the illumination spectral filter 60. In this exemplary embodiment, the observation spectral filter 48 is likewise embodied as a band-pass filter, with the observation spectral filter 48 being transmissive in a spectral range from approximately 620 nm to approximately 655 nm. The filter characteristic 66′ of the illumination spectral filter 60 has a filter curve 68′, according to which the illumination spectral filter 60 is embodied as a notch filter, the transmissivity of which complementing the transmissivity of the observation spectral filter 48. These filter characteristics 62′ and 66′ are suitable for the fluorescent dye protoporphyrin IX, the fluorescence maximum of which lies in the spectral range from approximately 620 nm to approximately 655 nm.

FIG. 6 shows an exemplary embodiment for filter characteristics 62″ and 66″ of the observation spectral filter 48 and the illumination spectral filter 60, in which the observation spectral filter 48 is embodied as a long-pass filter and the illumination spectral filter 60 is embodied as a short-pass filter, with the short-wavelength end of the filter curve 64″ and the long-wavelength end of the filter curve 68″ lying at a wavelength of approximately 760 nm. The filter characteristics 62″ and 68″ are particularly suitable for the case where a fluorescence diagnosis is carried out by means of the fluorescent dye ICG (indocyanine green).

In all exemplary embodiments as per FIGS. 4 to 6, the filter characteristics 62, 66 and 62′, 66′ and 62″, 66″ of the observation spectral filter 48 and the illumination spectral filter 60 complement one another, i.e. the mutually adjacent boundaries of the transmission ranges of the illumination spectral filter 60 and the observation spectral filter 48 are spaced apart by a wavelength of less than 15 nm in respect of the 50% transmission value of the filter curves 64, 68 and 64′, 68′ and 64″, 68″.

According to FIG. 3, a further observation spectral filter 70 is associated with the first image sensor 44, which restricts the spectral range of the light incident on the first image sensor 44 to the visible spectral range. Such a further observation spectral filter 70 can be a BG 39 filter by Schott AG, or can be another filter undefined with respect to the BG 39 filter. In FIGS. 4 to 6, the filter characteristic 72 of this further observation spectral filter 70 is in each case represented by a filter curve 74. The further observation spectral filter 70 reduces, in particular, spectral components of the light in the far red region of the visible spectrum.

Further details of the device 10 and the functionality thereof are described with reference to FIG. 1 in the following text.

During a fluorescence diagnosis, the device 10 is simultaneously operated in the white-light mode and in the fluorescence mode. The illumination spectral filter 60 is in the illumination path 20 in both the white-light mode and in the fluorescence mode. Likewise, the observation spectral filter 48 is arranged in the observation path 36 in both the white-light mode and in the fluorescence mode.

White light produced by the light source 16 is fed into the optical cable 22 through the illumination spectral filter 60 and routed via the optical waveguide 30 to the distal end 32 of the shaft 28 of the endoscope 26, where it emerges and illuminates a target region 75 as per the light-exit cone 35. By way of example, the target region 75 is a tissue area in the human or animal body, which should be examined in respect of the presence of malignant tissue. A fluorescent substance 76 situated in the target region 75 is excited to fluoresce by the illumination light. By way of example, the fluorescent substance 76 can be fluorescein, protoporphyrin or indocyanine green, with the filter characteristics of the illumination spectral filter 60 and the observation spectral filter 48 being configured as per FIGS. 4 to 6, corresponding to the respective fluorescent dye.

The fluorescent light emitted by the fluorescent dye 76, and the illumination light reflected by the target region 75, are received, according to an observation light cone 77, by the distal end 32 of the shaft 28 of the endoscope 26 and enter the distal end 78 of the observation path 36, in this case the optical-fibre bundle 38. The observation light is then directed to the proximal end, with only the fluorescence light impinging on the second image sensor 46 through the observation spectral filter 48 and the back-reflected illumination light (white light) impinging on the first image sensor 44.

The device 10 has a controller 80 for the first image sensor 44 and for the second image sensor 46, which operates the first image sensor 44 with a short exposure time and/or a low gain in order thus to obtain a white-light image with a high image quality.

By contrast, the controller 80 operates the second image sensor 46 with a long exposure time and/or a high gain and/or in a spatial integration mode in order to record as much of the low-intensity fluorescence light as possible.

More particularly, the controller 80 and the second image sensor 46 are capable of carrying out a spatially resolved determination of the fluorescence decay time by using a time-of-flight mode.

The image signals supplied by the image sensors 44 and 46 are then fed to an image processing system 82, which processes the received image signals and supplies these to image reproduction device 84, for example a colour monitor.

Here, the image processing system 82 is able, in the correct position, to superpose onto a white-light image 86 captured by the first image sensor 44 a fluorescence image 88 captured by the second image sensor 48, i.e. the fluorescence image 88 is superposed on the white-light image 86 in the correct position. Hence, the user can not only identify that malignant tissue is present in the target area 75 as a result of the fluorescence image 88; he can also precisely locate where the malignant tissue is in the target region 75.

Here, the fluorescence image 88 is superposed on the white-light image 86 in the form of a false-colour representation, as a result of which the contrast between the fluorescence image and the white-light image 86 can be amplified. Here, the false-colour representation can moreover provide different colours for different intensities of the fluorescent light in order thus to visualize the intensity profile of the fluorescence image 88.

Moreover, the image processing system 82 can be able to superpose the fluorescence image 88 on the white-light image 86 only if the fluorescence image 88 exceeds a predetermined intensity threshold or, from the whole area in the target region 75 from which fluorescence light is received by the second image sensor 46, only those local regions of the fluorescence image 88 are superposed on the white-light image 86 in which the predetermined intensity threshold is exceeded.

The device 10 is, as emerges from the preceding description, able to reproduce the white-light image 86 on the image reproduction equipment 84 with a very high image quality, in particular with high colour fidelity, without switching between the white-light mode and the fluorescence mode and, at the same time, is able to superpose the fluorescence image 88 on the white-light image 86 with great contrast to the white-light image 86.

If the second image sensor 46 is operated in a time-of-flight mode, the spatially resolved fluorescence decay time can be visualized. By way of example, the visualization can be implemented by means of a greyscale-value image or by encoding by means of false colours.

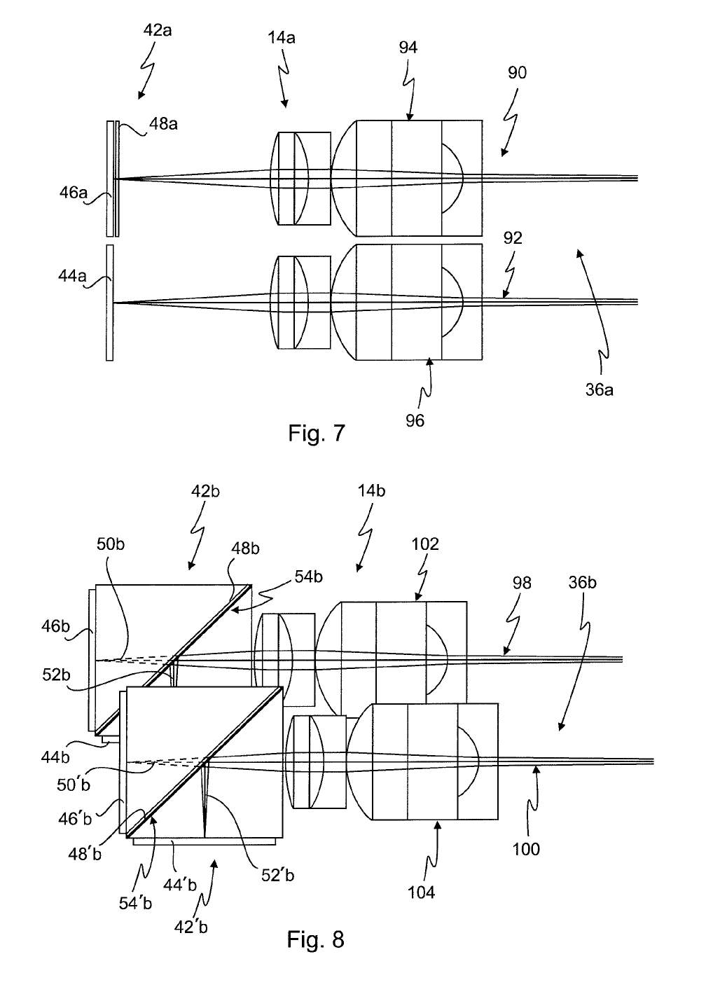

While the observation system 14 of the device 10 as per FIG. 1 has an observation path 36 which is a single channel in optical terms, or the endoscope 26 is embodied as a single-channel endoscope, FIGS. 7 and 8 show two exemplary embodiments in which the present invention can also be implemented in observation systems with two-channel optics, i.e. with a stereo endoscope or a stereo video endoscope.

FIG. 7 shows a first exemplary embodiment of such an implementation of an observation system 14a, which is a component of a stereo video endoscope. Parts of the observation system 14a that are equivalent or comparable to parts of the observation system 14 are provided with the same reference numerals as the parts of the observation system 14, but an “a” has been appended.

Such a stereo endoscope is then used in the device 10 in place of the endoscope 26.

The observation path 36a of the observation system 14a has an optical two-channel design, with a first optics channel 90 and a second optics channel 92. The observation system 14a has two image sensors 44a and 46a, as is conventional in stereo video endoscopes. A first objective 94 is associated with the image sensor 46a, and a second objective 96 is associated with the image sensor 44a. In this exemplary embodiment, the two optics channels 90 and 92 have an angle≠0° with respect to one another in respect of the target region to be observed, in this case the target region 75 as per FIG. 1; this corresponds to the viewing directions of the two eyes of a human.

In the observation system 14a, the first image sensor 44a serves for receiving a white-light image and the second image sensor 46a serves for receiving a fluorescence image. Accordingly, an observation spectral filter 48a is associated with the second image sensor 46a, the filter characteristic of which observation spectral filter for example is the filter characteristic 62 in FIG. 4, the filter characteristic 62′ in FIG. 5 or the filter characteristic 62″ in FIG. 6. The illumination spectral filter 60 as per FIG. 1 is accordingly matched to the filter characteristic of the observation spectral filter 48a.

In the exemplary embodiment shown in FIG. 7, the observation spectral filter 48a can be pivoted out of the beam path such that a white-light image with a stereoscopic effect, i.e. a 3D white-light image, is obtained with the two image sensors 46a and 44a. In the fluorescence mode, the observation spectral filter 48a is pivoted into the beam path, and, in the observation system 14, it is possible to visualize a white-light image with a fluorescence image superposed thereon.

The embodiment of the observation system 14a, which has a very simple design, is preferably considered if the target region 75 to be observed is at a sufficiently great distance from the objectives 94 and 96 in order to obtain, in the fluorescence mode, a superposition of the fluorescence image in the white-light image that is at the correct position.

FIG. 8 shows an embodiment of an observation system 14b, which is developed further with respect to FIG. 7, likewise implemented as stereo video endoscope observation system and also suitable for small distances to the target region 75.

The observation path 36b once again has a two-channel embodiment with a first optics channel 98 and a second optics channel 100. Arranged in the first optics channel 98 there is an objective 102 and arranged in the second optics channel 100 there is an objective 104.

The observation system 14b differs from the observation system 14a in respect of the number and arrangement of the image sensors.

In this embodiment, the first optics channel 98 is equipped with a camera 42b, which is identical to the camera 42 in FIG. 2. The camera 42 accordingly has a first image sensor 44b for receiving a white-light image and a second image sensor 46b for receiving a fluorescence image, an observation spectral filter 48b associated with the second image sensor 46b and a beam splitter 54b.

The second optics channel 100 has a camera 42′b which is identical thereto and has a first image sensor 44′b for receiving a white-light image, a second image sensor 46′b for receiving a fluorescence image, an observation spectral filter 48′b associated with the second image sensor 46′b and a beam splitter 54′b.

In this embodiment, it is possible to visualize a 3D white-light image and, at the same time superposed thereon, a fluorescence image.

An embodiment that is simplified with respect to the observation system 14b can consist of the second image sensor 46b or 46′b being omitted in one of the two cameras 42b or 42′b (and the corresponding beam splitter 54b or 54′b then being omitted or fully reflective), with the fluorescence image not being captured in a stereoscopic manner in that case.

What is claimed is:

1. A device for fluorescence diagnosis, comprising
an illumination system configured to illuminate a target region, having
a light source configured to produce white light,
an illumination path,
an illumination spectral filter arranged in the illumination path;
an observation system configured to observe the target region in a white-light mode and in a fluorescence mode, having
an observation path,
at least one first image sensor configured to receive a white-light image,
at least one second image sensor configured to receive a fluorescence image,
an observation spectral filter arranged in the observation path and associated with the second image sensor,
a beam splitter arranged in the observation path and dividing the observation path into a first sub-path and into a second sub-path, with light along the first sub-path being directed to the first image sensor and light along the second sub-path being directed to the second image sensor;
the observation spectral filter having a first filter characteristic configured such that light in a fluorescence spectral range of a fluorescence to be observed can be fed to the second image sensor while light in spectral ranges outside of the fluorescence is blocked;
the illumination spectral filter being arranged in the illumination path in both the white-light mode and the fluorescence mode, the illumination spectral filter having a second filter characteristic matched to the first filter characteristic of the observation spectral filter such that the target region is illuminated with a whole spectral range of the white light with exception of the fluorescence spectral range of the fluorescence to be observed.

2. The device of claim 1, wherein the second filter characteristic of the illumination spectral filter complements the first filter characteristic of the observation spectral filter associated with the second image sensor.

3. The device of claim 1, wherein the observation spectral filter associated with the second image sensor is a band-pass filter and the illumination spectral filter is a notch filter.

4. The device of claim 1, wherein a further observation spectral filter is associated with the first image sensor, said further observation spectral filter restricting a spectral range of the light incident on the first image sensor to the visible spectral range.

5. The device of claim 1, wherein, in direction of light propagation, the observation spectral filter associated with the second image sensor is arranged behind the beam splitter and in front of the second image sensor.

6. The device of claim 1, wherein the observation spectral filter associated with the second image sensor is integrated into the beam splitter.

7. The device of claim 6, wherein the observation spectral filter associated with the second image sensor is reflective in the fluorescence spectral range of the fluorescence to be observed and transmissive in a spectral range of the light from the white-light source outside the fluorescence spectral range.

8. The device of claim 6, wherein the observation spectral filter associated with the second image sensor is transmissive in the fluorescence spectral range of the fluorescence to be observed and reflective in a spectral range of the light from the white-light source outside the fluorescence spectral range.

9. The device of claim 1, further comprising a controller configured to operate the first image sensor with a short exposure time.

10. The device of claim 1, further comprising a controller configured to operate the first image sensor with small gain.

11. The device of claim 1, further comprising a controller configured to operate the second image sensor with a long exposure time.

12. The device of claim 1, further comprising a controller configured to operate the second image sensor with high gain.

13. The device of claim 1, further comprising a controller configured to control the second image sensor in a spatial integration mode.

14. The device of claim 11, wherein the controller is configured to operate the second image sensor in a time-resolved mode.

15. The device of claim 11, wherein the controller and the second image sensor are configured to determine the fluorescence decay time in a spatially resolved manner.

16. The device of claim 1, wherein the observation system has an image processing system configured to superpose in the correct position a white-light image captured by the first image sensor and a fluorescence image captured by the second image sensor

17. The device of claim 16, wherein the image processing system is configured to further superpose an image of a spatially resolved fluorescence decay time.

18. The device of claim 16, wherein the image processing system is configured to superpose the fluorescence image in the form of a false-colour representation on the white-light image.

19. The device of claim 16, wherein the image processing system is configured to superpose the fluorescence image onto the white-light image only if the fluorescence image exceeds a predetermined intensity threshold.

20. The device of claim 16, wherein the image processing system is configured to superpose only those local regions of the fluorescence image onto the white-light image in which a predetermined intensity threshold is exceeded.

21. The device of claim 1, wherein the observation system has an endoscope, into which at least one of the illumination path and the observation path is at least partly integrated.

22. The device of claim 21, wherein the endoscope is a stereo endoscope.
